(19) United States
(12) Patent Application Publication
(10) Pub. No.: US 2017/0356541 A1
(43) Pub. Date: Dec. 14, 2017

(54) Fastener-Free Idler Pulley

(71) Applicant: Ford Global Technologies, LLC, Dearborn, MI (US)

(72) Inventors: Joseph Alan Skrobowski, New Boston, MI (US); James M. Basile, Dundee, MI (US); Scott Willis, Gibraltar, MI (US)

(21) Appl. No.: 15/182,124

(22) Filed: Jun. 14, 2016

(51) Int. Cl. F16H 57/00; F16H 55/36

(52) U.S. Cl. CPC F16H 57/0031; F16H 55/36

(57) ABSTRACT

Belt-driven systems, such as a front-end accessory drive for an internal-combustion engine, often include one or more idler pulleys. It is typical for these idler pulleys to be retained by a bolt or bolt and washer. To obviate the bolt and washer, a fastener-less system has a shaft with a circumferential groove and a bearing with an inner race that has a circumferential ridge. An idler pulley is mounted on the bearing. The ridge engages with the groove of the shaft to retain the idler pulley/bearing on the shaft. Additionally, either a key inserted into keyways or stakes are used to avoid relative rotation of the inner race of the bearing with respect to the shaft.

### FIELD OF INVENTION

The present disclosure relates to an idler pulley mounting system and a method of manufacture and assembly.

### BACKGROUND

Many systems having belt-driven components include an idler pulley in the system. One example of a pulley system 10 for an internal combustion engine is shown in FIG. 1. A crankshaft pulley 12 coupled to the crankshaft of the engine (not shown) is the driver that provides the torque for the driven-components: air conditioner (A/C), water pump and fan, power steering pump (P/S), and an alternator, which are coupled to pulleys 24, 28, 20, and 26, respectively. In the example in FIG. 1, two idler pulleys 30 and 32 are included. A serpentine belt 40 rides on the periphery if all of the pulleys. Idler pulleys serve the function of causing belt 40 to wrap around a sufficient portion of the periphery of a driving or driven pulley so that there is enough friction to prevent belt slippage. Such an example is shown in FIG. 1 with idler pulley 30. If belt 40 is made shorter and idler pulley 30 is not included, belt 40 would stretch straight across between A/C pulley 24 and P/S pulley 20 making the circumferential contact between belt 40 and pulleys 24 and 20 less. Another reason for an idler pulley is to reduce the distance between adjacent pulleys to minimize belt flapping. Two examples of long uninterrupted belt runs, if idler pulleys 30 and 32 were removed, would be between crank pulley 12 and P/S pulley 20 and between P/S pulley 20 and A/C pulley 24.

In FIG. 1, two idler pulleys are shown. If the locations of the various pulleys in an engine package could be optimized for the front end accessory drive system, idler pulleys could in some situations be obviated. However, packaging is accomplished to satisfy many goals. Thus, idler pulleys are added as needed. In some applications, there are multiple belts for an internal combustion engine and many idler pulleys.

One example of an idler pulley-shaft assembly in an exploded view is shown in FIG. 2. Pulley 52 is coupled to a bearing 58. Pulley 52 and bearing 58 are slip fit over a shaft 60 that extends from an engine cover 62. A bolt 54 is slid through a washer 56 and bearing 58. Threads of bolt 54 are engaged with threads 64 of shaft 60. Bolt 54 is tightened to secure idler pulley 52 against engine cover 62. Bolt 54 and washer 56 keep pulley 52 from coming off shaft 60 as well keeping the inner portion of bearing 58 from rotating. The outer portion of bearing 58 and pulley 52 rotate. Bearing 58 can be a ball bearing, a roller bearing, or any suitable bearing type. In some alternatives, washer 56 is integrated with bolt 54. Particularly in engines with multiple idler pulleys, it is desirable to obviate the bolt and washer (or bolt with integrated washer) and mount the idler pulley without fasteners.

### SUMMARY

To obviate the bolt and washer used in the prior art, an idler pulley system is disclosed that includes: a shaft having a circumferential groove, a bearing having an inner race, the inner race having a circumferential ridge with the ridge engaged with the groove of the shaft, and an idler pulley mounted on the bearing.

The idler pulley system, in some embodiments, an axial slot is formed in the inner race of the bearing, an axial slot is formed on the shaft with the axial slot on the shaft aligned with the axial slot on the inner race, and a key is inserted into the aligned axial slots. In another embodiment, stakes formed by a chisel are formed in the shaft proximate an interface of the shaft and the inner race.

The idler pulley is press fit onto an outer race of the bearing forming an interference fit.

The bearing is pressed onto the shaft to cause the ridge of the inner race to seat into the groove of the shaft and the resulting clearances between the inner race and the ridge provides a slip fit.

The bearing is either a ball bearing with the balls disposed between the inner race and an outer race of the bearing or a needle bearing with needles disposed between the inner race and the outer race.

Also disclosed is idler pulley system having a shaft with a circumferential ridge, a bearing having an inner race and an outer race, and a circumferential groove on the inner race. The ridge is engaged with the groove.

In some embodiments, an axial slot is formed in the inner race of the bearing, an axial slot is formed on the shaft, and the axial slot on the shaft is aligned with the axial slot on the inner race. A key is inserted into the aligned axial slots. In other embodiments, stakes are formed by a chisel, the stakes being proximate an interface of the shaft and the inner race.

The idler pulley is press fit onto an outer race of the bearing forming an interference fit.

Also disclosed is a method to fabricate and install an idler pulley system that includes: fabricating a roller bearing having an inner race having a first circumferential feature, fabricating a second circumferential feature on a shaft, press fitting a pulley onto an outer race of the roller bearing, and pressing the bearing/pulley assembly over the shaft with the first and second circumferential features engaging.

In some embodiments, the first circumferential feature is a ridge and the second circumferential feature is a groove. In other embodiments, the first circumferential feature is a groove and the second circumferential feature is a ridge.

The roller bearing is one of a ball bearing and a needle bearing.

In some embodiments, the method also includes: forming an axial keyway in the shaft, forming an axial keyway in the inner race of the bearing, aligning the keyways, and inserting a key into the keyways. In other embodiments, the shaft is staked to the inner race of the bearing.

One advantage according to the present disclosure is that part count and cost is reduced. The assembly operation of threading the bolt into the shaft is now obviated. Instead the idler pulley is snapped onto the shaft.

### BRIEF DESCRIPTION OF THE DRAWINGS

FIG. 1 is an illustration of a front-end accessory drive according to the prior art;

FIG. 2 is an illustration of a idler pulley in an exploded view according to the prior art;

FIGS. 3 and 4 are representations each showing a bearing and a shaft according to embodiments of the disclosure;

FIGS. 5 and 6 are cross sections of the bearings and shafts of FIGS. 3 and 4, respectively;

FIGS. 7 and 8 are end view each showing an idler pulley assembly according to embodiments of the disclosure; and

FIG. 9 is a flow chart to manufacture and assemble an idler pulley assembly showing embodiments of the disclosure.

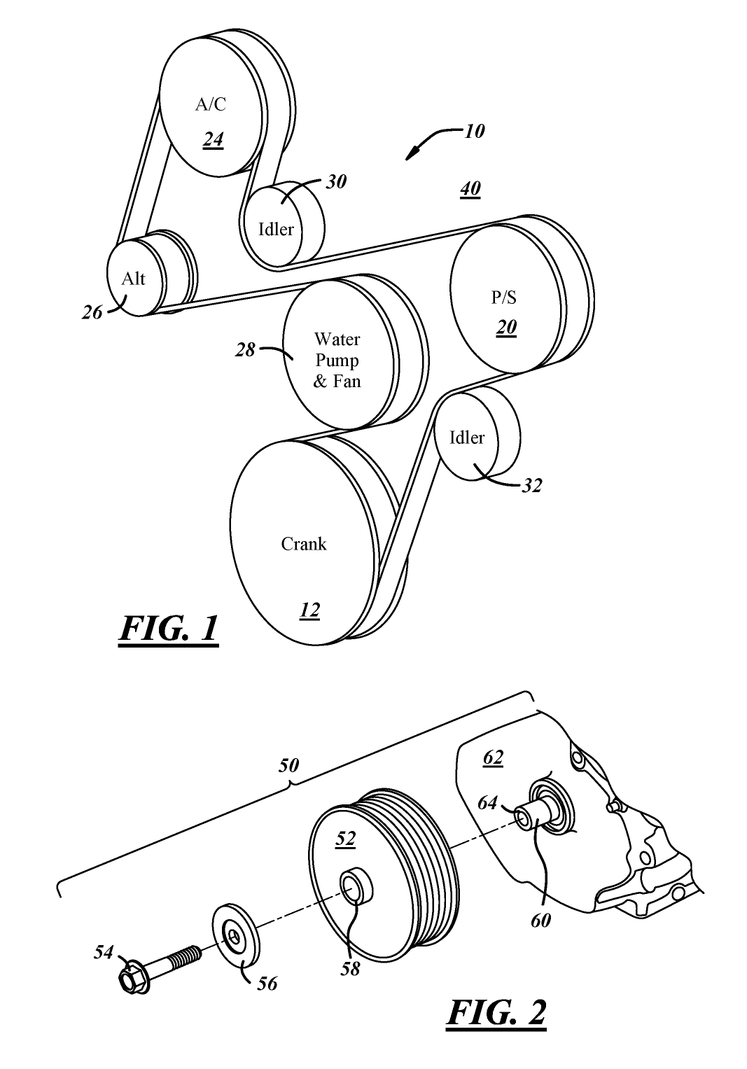

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

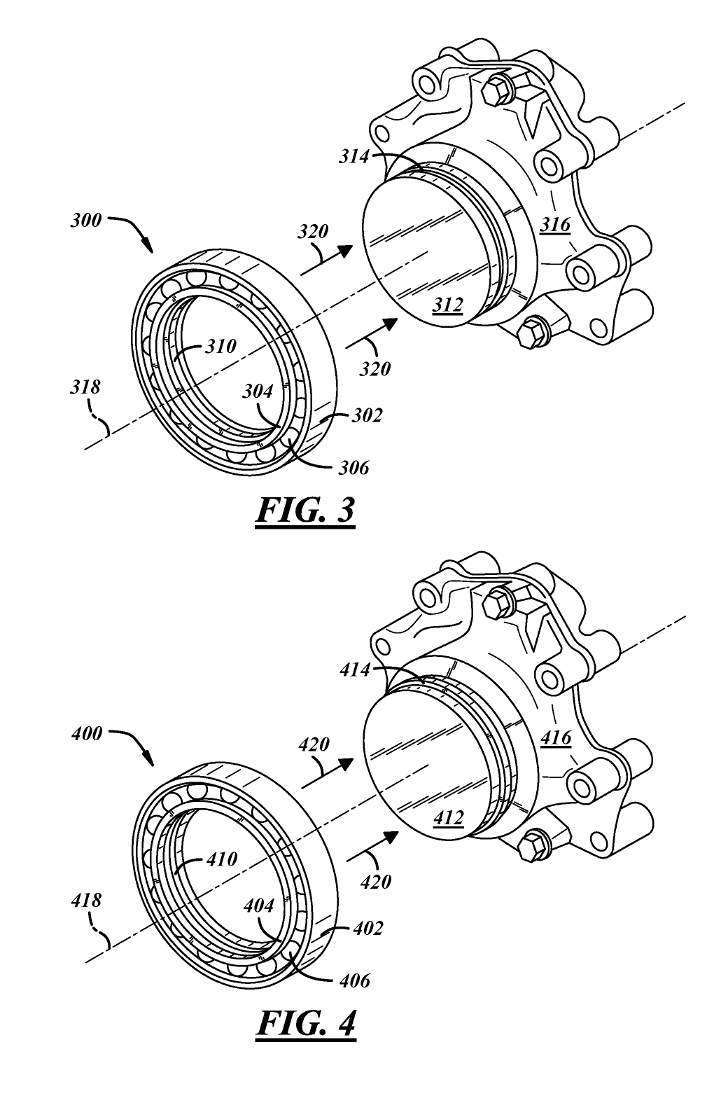

A bearing 300 has an outer race 302 and an inner race 304 with a plurality of balls 306 contained between races 302 and 304. An idler pulley (not shown) is press fit (interference fit) or molded onto outer race 302. In the embodiment shown in FIG. 3, inner race 304 has a circumferential ridge 310 that extends into toward the center. A shaft 312 that is coupled to an engine cover 316, a portion of which is shown in FIG. 3, has a circumferential groove 314 formed therein. A central axis of bearing 300 and shaft 312 is axis 318. When aligned, the two are coupled by moving bearing 300 in the direction of arrows 320 to slip fit bearing 300 over shaft 312. Inner race 304 forms a slip fit with shaft 312. Groove 314 of shaft 312 engages with ridge 310 of bearing 300. Bearing 300 is pressed onto shaft 312 for groove 314 to engage with ridge 310. Otherwise, inner race 302 and shaft 312 are dimensioned to provide a slip fit.

An alternative configuration in FIG. 4 shows a bearing 400 with an inner race 404 that has a circumferential groove 410. Balls 406 are contained between inner race 404 and outer race 402. A shaft 412 coupled to an engine cover 416 has a circumferential ridge 414 that engages with groove 410 when bearing 400 is slid over shaft 412 along central axis 418 in the direction of arrows 420.

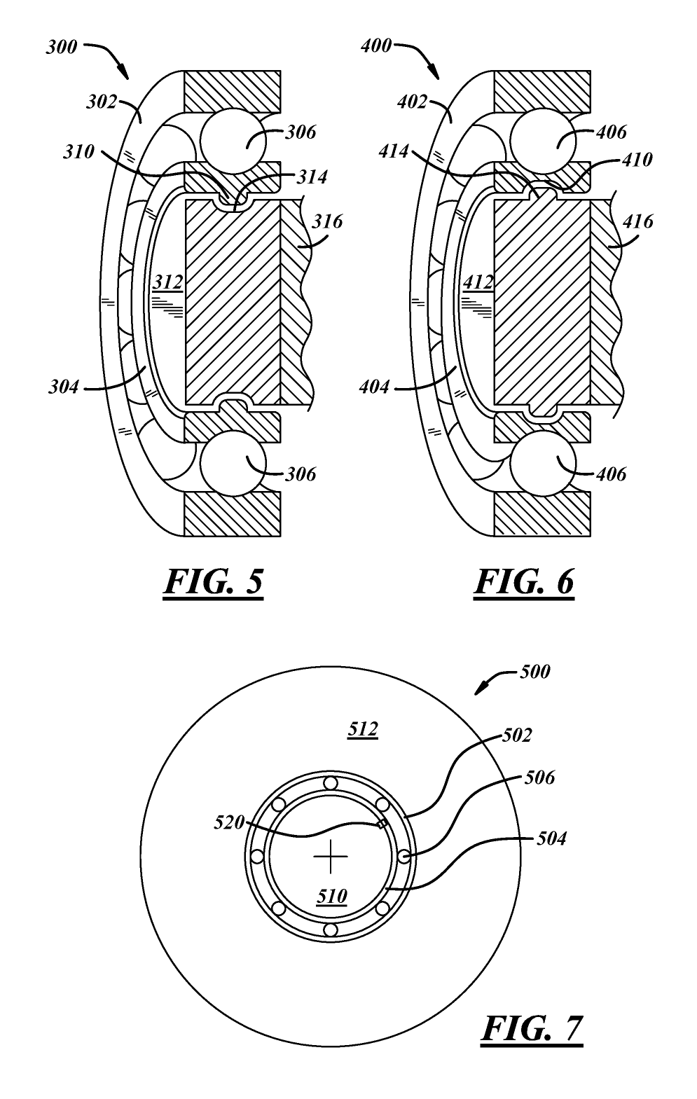

A portion of the bearing and shaft shown in FIG. 3 are shown in FIG. 5 in cross section. Ridge 310 of bearing 300 engages with groove 314 of shaft 312. In FIG. 6, bearing 400 has groove 410 that engages with ridge 414 of shaft 412.

The groove and ridge on the inner race of the bearing and the shaft keep the idler pulley from coming off the shaft in the axial direction. Additionally, the inner race of the bearing should not rotate with respect to the shaft. To prevent that, in one embodiment, a key is provided in FIG. 7, which shows one embodiment of an idler pulley system 500. An idler pulley 512 is mounted onto an outer race 502 of a bearing. The bearing also includes an inner race 504 and balls or needles 506 between races 502 and 504. Both inner race 504 and a shaft 510, onto which inner race 504 is mounted, are provided with an axial groove, a keyway. A key 520 is inserted into the aligned keyways in inner race 504 and shaft 510.

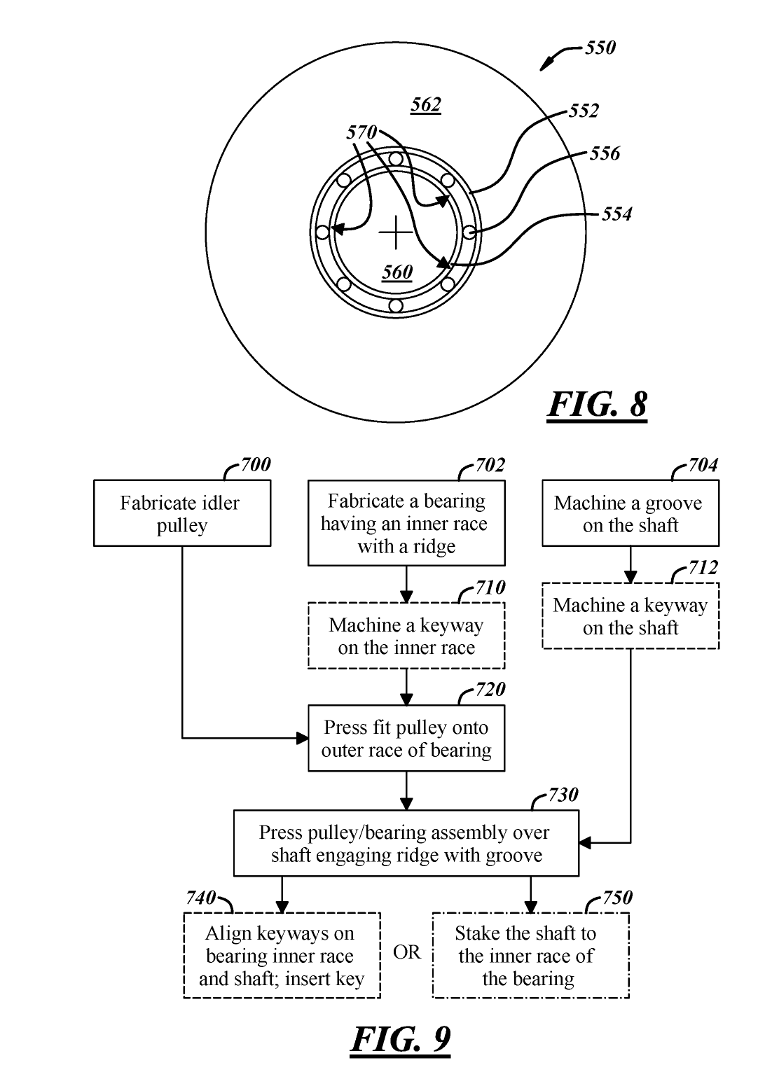

An alternative embodiment for preventing relative rotation of the shaft and the inner race is shown in FIG. 8, which shows an idler pulley system 550. An idler pulley 562 is mounted on an outer race 554 of a bearing. Balls or needles 556 are contained between outer race 552 and an inner race 554. Idler pulley 562 and the bearing are slid over a shaft 560. A chisel or staking punch is used to deform the metal in a few places around the periphery of shaft 560 to form an interference fit in those locations. In

FIG. 6, three such stakes 570 are shown. As races 552 and 554 of the bearing are hardened by heat treating, staking is applied to shaft 560 to deform material to engage with race 552.

Referring to FIG. 9, a number of alternative embodiments for manufacturing and assembling the idler pulley assembly. In box 700, the idler pulley is fabricated; in block 702, a bearing is fabricated. The inner race has a circumferential ridge. The bearing may be a ball bearing, a needle bearing, or any suitable alternative. In block 704, a circumferential groove is machined into a shaft. In embodiments including a keyway: an axial keyway is machined into the inner race of the bearing in block 710 and an axial keyway is machined into the shaft in block 712. In block 720, the pulley is press fit onto the outer race of the bearing. In an alternative embodiment not shown in FIG. 9, the pulley is molded onto the outer race of the bearing. In block 730, the pulley/bearing assembly is pressed over the shaft causing the ridge to engage with the groove. In alternatives with the key pressed into keyway, the keyways on the bearing and the shaft are aligned and then a key is inserted into the aligned keyways in block 740. Alternatively, in systems using staking, a chisel is used to deform material proximate the interface of the shaft and the inner race of the bearing, in block 750, to thereby prevent relative rotation of those two components.

In FIG. 9, the inner race of the bearing has a ridge that engages with the groove of the shaft. In an alternative, the bearing has a groove and the shaft has a ridge.

A front-end accessory drive for an internal-combustion engine is described as one system to which the present disclosure applies. The present disclosure applies to any system including belt-driven accessories in which an idler pulley is included.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

1. An idler pulley system, comprising:
a shaft having a circumferential groove;
a bearing having an inner race, the inner race having a circumferential ridge with the ridge engaged with the groove of the shaft; and
an idler pulley mounted on the bearing.

2. The idler pulley system of claim 1, further comprising:
an axial slot formed in the inner race of the bearing;
an axial slot formed on the shaft with the axial slot on the shaft aligned with the axial slot on the inner race; and
a key inserted into the aligned axial slots.

3. The idler pulley system of claim 1, further comprising: stakes formed by a chisel, the stakes being proximate an interface of the shaft and the inner race.

4. The idler pulley system of claim 1 wherein the idler pulley is press fit onto an outer race of the bearing forming an interference fit.

5. The idler pulley system of claim 1 wherein the idler pulley is molded over an outer race of the bearing.

6. The idler pulley system of claim 1 wherein:
the bearing is pressed onto the shaft to cause the ridge of the inner race to seat into the groove of the shaft; and
the resulting clearances between the inner race and the ridge provides a slip fit.

7. The idler pulley system of claim 1 wherein the bearing is one of a ball bearing with the balls disposed between the inner race and an outer race of the bearing and a needle bearing with needles disposed between the inner race and the outer race.

8. An idler pulley system, comprising:
a shaft having a circumferential groove;
a bearing having an inner race and an outer race; and
an idler pulley mounted on the outer race wherein a ridge is formed in an inner surface of the inner race; and the ridge of the inner race is engaged with the circumferential groove of the shaft.

9. The idler pulley system of claim 8, further comprising:
an axial slot formed in the inner race of the bearing;
an axial slot formed on the shaft with the axial slot on the shaft aligned with the axial slot on the inner race; and
a key inserted into the aligned axial slots.

10. The idler pulley system of claim 8, further comprising: stakes formed by a chisel, the stakes being proximate an interface of the shaft and the inner race.

11. The idler pulley system of claim 8 wherein the idler pulley is press fit onto an outer race of the bearing forming an interference fit.

12. The idler pulley system of claim 8 wherein the idler pulley is molded onto an outer race of the bearing.

13-20. (canceled)

21. An idler pulley system, comprising:
a shaft with a circumferential feature;
a roller bearing having an inner race having an inner surface with a circumferential feature with the circumferential feature of the shaft nested with the circumferential feature of the inner race wherein: the roller bearing also has an outer race on which a pulley is affixed.

22. The idler pulley system of claim 21 wherein the roller bearing is pressed onto the shaft.

23. The idler pulley system of claim 21 wherein the roller bearing is staked to the shaft.

24. The idle pulley system of claim 21, further comprising: a pulley press fit onto the outer race.

25. The idler pulley system of claim 21 further comprising: a pulley molded onto the outer race.

26. The idler pulley system of claim 21 wherein the roller bearing has one of: balls and needles situated between the inner and outer races.

27. The idler pulley system of claim 21 wherein the circumferential feature on the shaft is a groove; and the circumferential feature on the inner race is a ridge.
